(19) United States
(12) Patent Application Publication
(10) Pub. No.: US 2004/0238186 A1
(43) Pub. Date: Dec. 2, 2004

(54) Fire fighting method and apparatus

(76) Inventor: James Michael O'Dwyer, Queensland (AU)

Correspondence Address: FINNEGAN, HENDERSON, FARABOW, GARRETT & DUNNER, LLP, 1300 I STREET, NW, WASHINGTON, DC, 20005, US

(21) Appl. No.: 10/482,664

(22) PCT Filed: Jul. 3, 2002
(86) PCT No.: PCT/AU02/00854

(30) Foreign Application Priority Data
Jul. 6, 2001 (AU) PR 6197

(51) Int. Cl. A62C 8/00

(52) U.S. Cl. 169/47; 169/70; 169/36

(57) ABSTRACT

A fire fighting apparatus (20) for fighting a fire (10) having a relatively large area or volume (11, 12), said apparatus including a targeting system (23) for identifying a target area to be doused with fire retardant and an ordnance (21) for discharging a multiplicity of projectiles (22) having the fire retardant contained therein (32). The ordnance of the apparatus includes at least one barrel assembly (30), said at least one barrel assembly having a barrel (39), a plurality of projectiles (35) axially disposed within the barrel for operative sealing engagement with the bore of the barrel (39), and discrete propellant charges (36) for propelling respective projectiles sequentially through the muzzle of the barrel, whereby said fire retardant is dispersed over the target area or within the target volume.

### CROSS-REFERENCE TO RELATED APPLICATIONS

The present application is related to the applicant's co-pending International Patent Application No. PCT/AU00/00296 entitled “Projectile launching apparatus” filed 7 Apr. 2000 and published as WO 00/62004 on 19 Oct. 2000.

### BACKGROUND OF THE INVENTION

1. Field of the Invention

The present invention relates to fire fighting. In particular, although not exclusively, the present invention relates to methods of, and apparatus for, fighting fires having a relatively large expanse.

2. Discussion of the Background Art

Fires which extend over a large expanse, in either two dimensions such as a grass fire or three dimensions such as in a bush or forest fire, industrial or chemical fires or a multi-story building, present particular problems in regard to delivering fire retardant or dousing materials quickly and precisely over threatened areas, whilst minimising risks for fire fighters and surrounding assets.

Conventional fire fighting techniques typically involve controlling progress of an expansive fire at a perimeter, which may involve back burning. Back burning operations also involve inherent risk, especially in the case of a change in the direction of prevailing winds.

It is also known to use airborne delivery of fire suppressants wherein suppressant material is dropped into a fire from above, for example by water bombing by fixed or rotary wing aircraft. However, this is a relatively costly technique requiring special purpose aircraft and skilled pilots for maximum effect.

Furthermore, the presence of toxic fumes or other by-products of industrial or chemical fires, together with the possibility of explosions and debris propelled by such explosions, may pose additional risks to those fighting fires, not to mention other persons and fixed assets in the vicinity. Accordingly, it is highly desirable that such fires be fought from a relatively safe distance.

### SUMMARY OF THE INVENTION

### Object of the Invention

The invention aims to provide a method of fire fighting that permits an expanse of fire to be, substantially simultaneously, doused with a fire retardant thereby making the fire easier to contain and ultimately to completely extinguish.

The invention also aims to provide a fire fighting apparatus having improved performance over conventional fire fighting units and appliances.

### Disclosure of the Invention

Accordingly there is provided a method of fire fighting wherein said method includes identifying an target area to be doused with fire retardant and discharging a multiplicity of projectiles having the fire retardant contained therein from an ordnance having at least one barrel assembly, said at least one barrel assembly having a barrel, a plurality of projectiles axially disposed within the barrel for operative sealing engagement with the bore of the barrel, and discrete propellant charges for propelling respective projectiles sequentially through the muzzle of the barrel whereby said fire retardant is dispersed over the target area.

In another aspect there is provided a fire fighting apparatus including a targeting system for identifying a target area to be doused with fire retardant and an ordnance for discharging a multiplicity of projectiles having the fire retardant contained therein from said ordnance wherein said ordnance includes at least one barrel assembly, said at least one barrel assembly having a barrel, a plurality of projectiles axially disposed within the barrel for operative sealing engagement with the bore of the barrel, and discrete propellant charges for propelling respective projectiles sequentially through the muzzle of the barrel whereby said fire retardant is dispersed over the target area.

It has been found that by dousing “hot spots” in a fire the intensity of the fire may be reduced. Thus conventional fire fighting techniques may be made more effective. Advantageously infra-red targeting systems may be used in the present invention to assist in identifying and targeting “hot spots” or other selected locations within a fire. Alternatively visual identification of a target area may be utilised.

The target area may be selected as a “hot spot” as described above. Alternatively the target area may be selected to assist in protecting people or property from fire. For example, in order to assist fire fighters or victims trapped by fire to escape from danger, a target area in the form of a corridor or escape route may be identified.

The type of fire retardant that may be deployed in the method of the present invention includes a wide variety of fire retardants. Fire retardants are generally classified as types A, B or C and may be used on fires that burn on different fuel sources. The method of the present invention may deploy a powder retardant that is suitable on all classes of fire. Alternatively, a multiplicity of barrel assemblies may be used to selectively fire a variety of fire retardants, including gels and gases, that may be selected to suit the particular fire.

The ordnance includes a number of barrel assemblies including a barrel; a plurality of projectiles axially disposed within the barrel for operative sealing engagement with the bore of the barrel, and discrete propellant charges for propelling respective projectiles sequentially through the muzzle of the barrel discharge projectiles to douse the fire. Such barrel assemblies are described in the present applicant's earlier International Patent Application Nos. PCT/AU94/00124, PCT/AU96/00459 and PCT/AU97/00713.

The projectile may be round, conventionally shaped or dart-like and the fins thereof may be offset to generate a stabilising spin as the dart is propelled from a barrel that may be a smooth-bored barrel. The projectile charge may be form as a solid block to operatively space the projectiles in the barrel or the propellant charge may be encased in metal or other rigid case which may include an embedded primer having external contact means adapted for contacting a pre-positioned electrical contact associated with the barrel. For example the primer could be provided with a sprung contact which may be retracted to enable insertion of the cased charge into the barrel and to spring out into a barrel aperture upon alignment with that aperture for operative contact with its mating barrel contact. If desired the outer case may be consumable or may chemically assist the propellant burn. Furthermore an assembly of stacked and bonded or separate cased charges and projectiles may be provided for reloading a barrel.

Each projectile may include a projectile head and extension means for at least partly defining a propellant space. The extension means may include a spacer assembly that extends rearwardly from the projectile head and abuts an adjacent projectile assembly.

The spacer assembly may extend through the propellant space and the projectile head whereby compressive loads are transmitted directly through abutting adjacent spacer assemblies. In such configurations, the spacer assembly may add support to the extension means which may be a thin cylindrical rear portion of the projectile head. Furthermore the extension means may form an operative sealing contact with the bore of the barrel to prevent burn leakage past the projectile head.

The spacer assembly may include a rigid collar which extends outwardly to engage a thin cylindrical rear portion of the malleable projectile head inoperative sealing contact with the bore of the barrel such that axially compressive loads are transmitted directly between spacer assemblies thereby avoiding deformation of the malleable projectile head.

Complementary wedging surfaces may be disposed on the spacer assembly and projectile head respectively whereby the projectile head is urged into engagement with the bore of the barrel in response to relative axial compression between the spacer means and the projectile head. In such arrangement the projectile head and spacer assembly may be loaded into the barrel and there after an axial displacement is caused to ensure good sealing between the projectile head and barrel. Suitably the extension means is urged into engagement with the bore of the barrel.

The projectile head may define a tapered aperture at its rearward end into which is received a complementary tapered spigot disposed on the leading end of the spacer assembly, wherein relative axial movement between the projectile head and the complementary tapered spigot causes a radially expanding force to be applied to the projectile head.

The barrel may be non-metallic and the bore of the barrel may include recesses that may fully or partly accommodate the ignition means. In this configuration the barrel houses electrical conductors which facilitate electrical communication between the control means and ignition means. This configuration may be utilised for disposable barrel assemblies that have a limited firing life and the ignition means and control wire or wires therefor can be integrally manufactured with the barrel.

A barrel assembly may alternatively include ignition apertures in the barrel and the ignition means are disposed outside the barrel and adjacent the apertures. A non-metallic outer barrel that may include recesses adapted to accommodate the ignition means may surround the barrel. The outer barrel may also house electrical conductors that facilitate electrical communication between the control means and ignition means. The outer barrel may be formed as a laminated plastics barrel which may include a printed circuit laminate for the ignition means.

The barrel assembly may have adjacent projectiles that are separated from one another and maintained in spaced apart relationship by locating means separate from the projectiles, and each projectile may include an expandable sealing means for forming an operative seal with the bore of the barrel. The locating means may be the propellant charge between adjacent projectiles and the sealing means suitably includes a skirt portion on each projectile which expands outwardly when subject to an in-barrel load. The in-barrel load may be applied during installation of the projectiles or after loading such as by tamping to consolidate the column of projectiles and propellant charges or may result from the firing of an outer projectile and particularly the adjacent outer projectile.

The rear end of the projectile may include a skirt about an inwardly reducing recess such as a conical recess or a part-spherical recess or the like into which the propellant charge portion extends and about which rearward movement of the projectile will result in radial expansion of the projectile skirt. This rearward movement may occur by way of compression resulting from a rearward wedging movement of the projectile along the leading portion of the propellant charge it may occur as a result of metal flow from the relatively massive leading part of the projectile to its less massive skirt portion.

Alternatively the projectile may be provided with a rearwardly divergent peripheral sealing flange or collar which is deflected outwardly into sealing engagement with the bore upon rearward movement of the projectile. Furthermore the sealing may be effected by inserting the projectiles into a heated barrel which shrinks onto respective sealing portions of the projectiles. The projectile may comprise a relatively hard mandrel portion located by the propellant charge and which cooperates with a deformable annular portion may be moulded about the mandrel to form a unitary projectile which relies on metal flow between the nose of the projectile and its tail for outward expansion about the mandrel portion into sealing engagement with the bore of the barrel.

The projectile assembly may include a rearwardly expanding anvil surface supporting a sealing collar thereabout and adapted to be radially expanded into sealing engagement with the barrel bore upon forward movement of the projectile through the barrel. In such a configuration it is preferred that the propellant charge have a cylindrical leading portion which abuts the flat end face of the projectile.

The projectiles may be adapted for seating and/or location within circumferential grooves or by annular ribs in the bore or in rifling grooves in the bore and may include a metal jacket encasing at least the outer end portion of the projectile. The projectile may be provided with contractible peripheral locating rings that extend outwardly into annular grooves in the barrel and that retract into the projectile upon firing to permit its free passage through the barrel.

The electrical ignition for sequentially igniting the propellant charges of a barrel assembly may preferably include the steps of igniting the leading propellant charge by sending an ignition signal through the stacked projectiles, and causing ignition of the leading propellant charge to arm the next propellant charge for actuation by the next ignition signal. Suitably all propellant charges inwardly from the end of a loaded barrel are disarmed by the insertion of respective insulating ruses disposed between normally closed electrical contacts.

Ignition of the propellant may be achieved electrically or ignition may utilise conventional firing pin type methods such as by using a centre-fire primer igniting the outermost projectile and controlled consequent ignition causing sequential ignition of the propellant charge of subsequent rounds. This may be achieved by controlled rearward leakage of combustion gases or controlled burning of fuse columns extending through the projectiles.

In another form the ignition is electronically controlled with respective propellant charges being associated with primers which are triggered by distinctive ignition signals. For example the primers in the stacked propellant charges may be sequenced for increasing pulse width ignition requirements whereby electronic controls may selectively send ignition pulses of increasing pulse widths to ignite the propellant charges sequentially in a selected time order. Preferably however the propellant charges are ignited by a set pulse width signal and burning of the leading propellant charge arms the next propellant charge for actuation by the next emitted pulse.

Suitably in such embodiments all propellant charges inwardly from the end of a loaded barrel are disarmed by the insertion of respective insulating fuses disposed between insertion of respective insulating fuses disposed between normally closed electrical contacts, the fuses being set to burn to enable the contacts to close upon transmission of a suitable triggering signal and each insulating fuse being open to a respective leading propellant charge for ignition thereby.

A number of projectiles can be fired simultaneously, or in quick succession, or in response to repetitive manual actuation of a trigger, for example. In such arrangements the electrical signal may be carried externally of the barrel or it may be carried through the superimposed projectiles which may clip on to one another to continue the electrical circuit through the barrel, or abut in electrical contact with one another. The projectiles may carry the control circuit or they may form a circuit with the barrel.

The fire fighting capabilities of the method and apparatus of the present invention may advantageously be applied to fighting fires in a relatively flat, two-dimensional plane. The projectiles containing fire retardant may be detonated to disperse the fire retardant in a simple plane. For example, the surface of the fuel source which feeds grass fires, and spilled fuel fires is generally a rather flat two dimensional plane which is often horizontal. These fires can be effectively engaged by the mortar box means of distributing impact activated ‘grenades’ that release fire retardant powder. Although grass and brush may have a vertical fuel depth of say two metres, such a depth can generally be expected to be doused with fire retardant by the normal distribution effect of impact bursting grenades.

It may be preferable to burst the grenades and disperse the fire retardant above the plane of the fire. This may be done by the use of a laser device or the like which might be attached to a truck, or which could operate separately or in a hand held manner. The purpose of the laser signal would be to broadcast a horizontal or otherwise preferred shaped signal above the fire, to be received by a the grenades and to initiate the timing of the release of the powder. In this way all of the grenades would burst at a designated height above the fire, and thereby more effectively douse the flames with fire retardant that may settle onto the source of the fire. The projectiles may burst and deploy the fire retardant by use of a small explosive charge. Alternatively a mechanical assembly may be used to deploy the fire retardant.

The grenades may be stacked in a mortar box to have a range of response times so that a calculated percentage of them burst at the time the signal is received, while others burst at a number of delayed times. The result of which may be that some grenades burst above the flames, some burst in the flames and in the case of tall grass and brush some burst in the fuel column. Others may remain as impact activated grenades. In this way, fuel structures such as branches and the like which might otherwise only be ‘dusted’ from the top, would also be dusted from below, and the material in vertical fuel column would be more effectively covered.

The grenades may receive signals of when to burst from a variety of other sources, such as radio frequency, and any other suitable means. Additionally the projectiles may be heat activated in that they include means for bursting, in part or in total, initiated by the heat of the fire.

Finned or otherwise controlled projectiles may be fitted with heat sensors, infa-red for example, such that projectiles which might otherwise fall outside the fire perimeter, or more than a preferred distance outside the fire perimeter, would autonomously change course to fall inside the desired perimeter.

The method and apparatus of the present invention may also be employed in dousing fires that are burning in a more three dimensional volume. For example forest fires, in which case the vertical fuel column and the resulting flame column can be a considerable height may be attacked in accordance with the present invention. For instance it would not be uncommon for a forest fire to be operating in a vertical fuel column stretching from the floor of the forest to the top of the canopy. The height of this vertical fuel column makes the task of extinguishing the flames much greater than would be the case as described with grass and brush. A far greater number of grenades are required and an effective means of distributing the bursting of the grenades within the fire column is desired. It is preferred that a means of ensuring that the grenades burst at various depths in the column, to provide effective coverage of the column with fire retardant powder is provided.

Preferably the projectiles or grenades may be discharged into such fires from an aircraft. Additionally, in the forest fire/aircraft scenario, GPS may be used to establish the height of the aircraft, the height and contour of the forest floor, and this information can be electronically transferred to the mortars during firing. Radar may also be used to determine the height of the aircraft above the forest floor, and the height of the top of the canopy. This information may be used to provide bursting instructions to the projectiles.

The trajectory of the grenades can be calculated by computer to accommodate wind, altitude, aircraft height and speed, forest floor contour and it may thus be available for an operator in the aircraft to have a VDU screen which can overlay the possible impact footprint of a firing onto an infra-red image of the fire. In this way, and/or where available with visual confirmation of the situation, the operator will be able to commence firing at a preferred moment, and will be able to engage the hottest seat of the flames. Further the present invention may be used to deploy fire retardant as a fire break.

Alternatively, the monitor may permit zones within the designated area to be avoided such that either the quantity of fire retardant deployed is minimised.

The use of autonomous control means and infra-red sensors on the grenades can reduce off-target waste, and more effectively concentrate the powder onto the fire.

In one embodiment, the barrel assemblies may be splayed relative to each other to concentrate or diffuse the fire from the mortar box dependent upon the nature of the fire.

### BRIEF DETAILS OF THE DRAWINGS

In order that this invention may be more readily understood and put into practical effect, reference will now be made to the accompanying drawings which illustrate typical embodiments of the invention wherein:

FIG. 1 is an illustration of a fire for which the method of the present invention is applicable;

FIG. 2 is an illustration of a fire fighting unit of a first embodiment for use in the present invention;

FIG. 3 is an illustration of a fire fighting unit of a second embodiment for use in the present invention;

FIG. 4 is an cross-sectional view of a barrel assembly for use in either of the first and second embodiments; and

FIG. 5 is a block diagram of a control means for use with an airborne fire fighting unit of third embodiment of the invention.

### DESCRIPTION OF PREFERRED EMBODIMENTS OF THE INVENTION

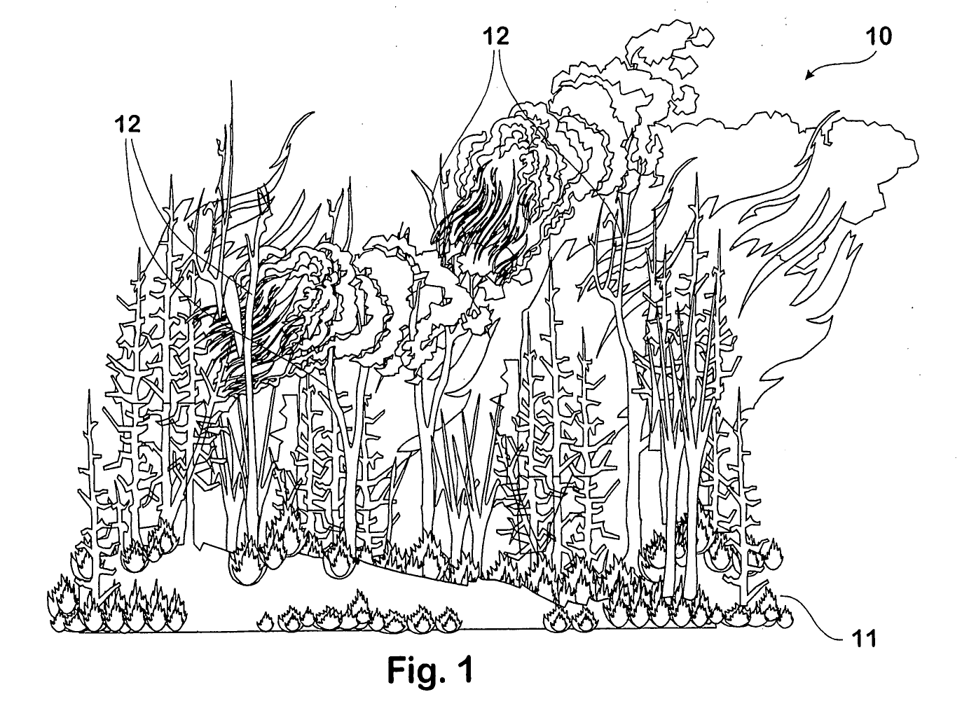

FIG. 1 shows a bush fire 10 that is burning both on the ground 11 and throughout the fuel column defined by the trees 12. In one embodiment of the present invention the fire retardants are configured to burst and deploy fire retardant at various heights above the ground and on the ground so as to quench the fire 10 throughout its depth.

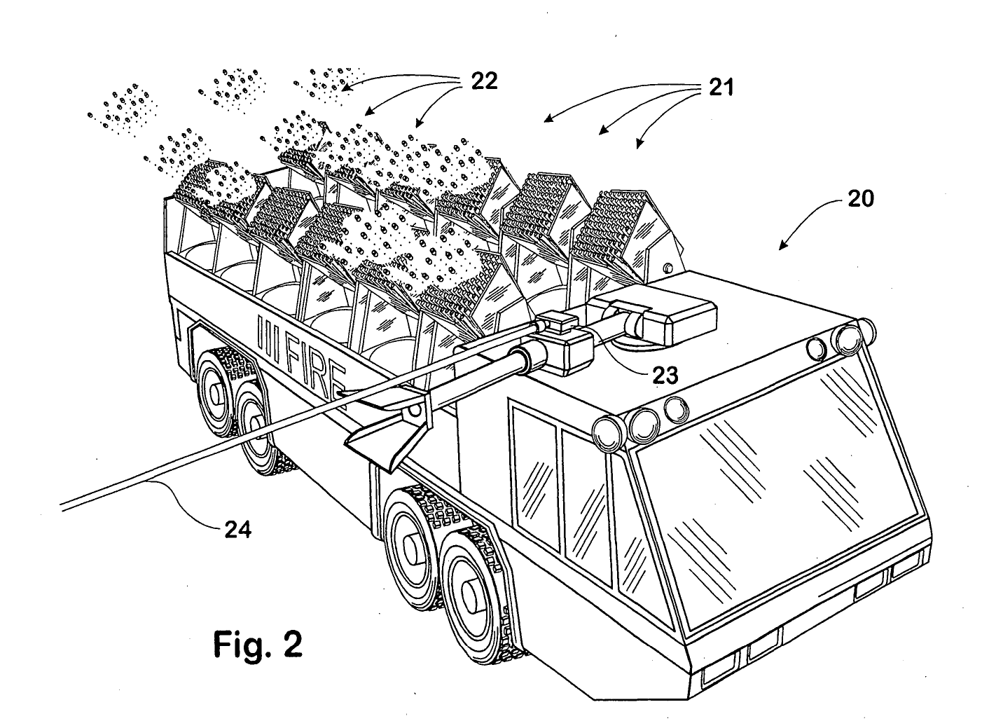

FIG. 2 shows a fire fighting unit in the form of a truck 20. The fire fighting unit may also be airborne such as an aircraft or helicopter. The fire fighting unit includes a number of pods 21 of barrel assemblies for firing projectiles 22 carrying fire retardant. The fire fighting unit also has a laser guidance system 23 for directing the projectiles 22 containing fire retardant. It will be appreciated that the pods may be rotatably mounted on the rear of the truck in order that they may be aimed by the laser guidance system 23.

In one particular form of the invention the laser guidance system 23 may have an alternate mode of operation wherein the beam 24 produced by the guidance system is sweep at a designated height above ground. The sweep beam effectively broadcasts a signal to the projectiles to initiate the release of the fire retardant. It will be appreciated that other means, such as radio frequency signals, may be employed to communicate a burst or release signal to the projectiles. Some projectiles may also include heat sensors for reactive release of retardant in non-homogeneous fire conditions.

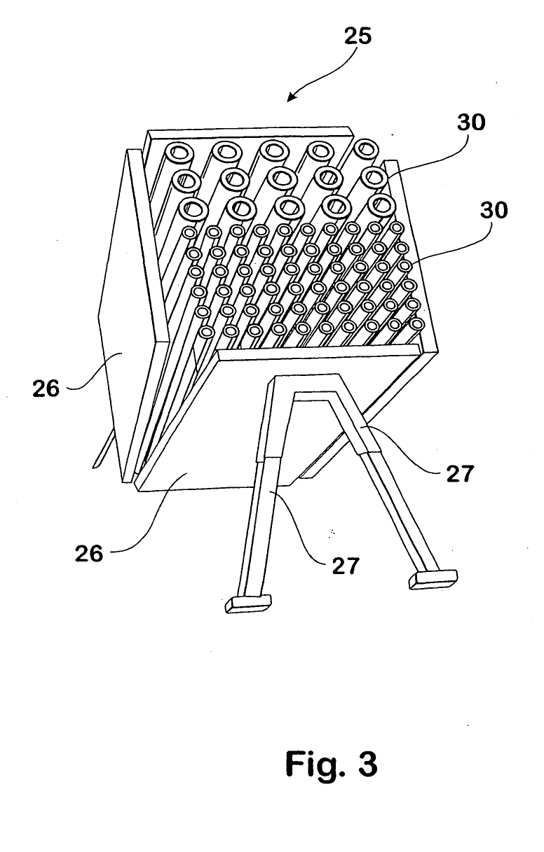

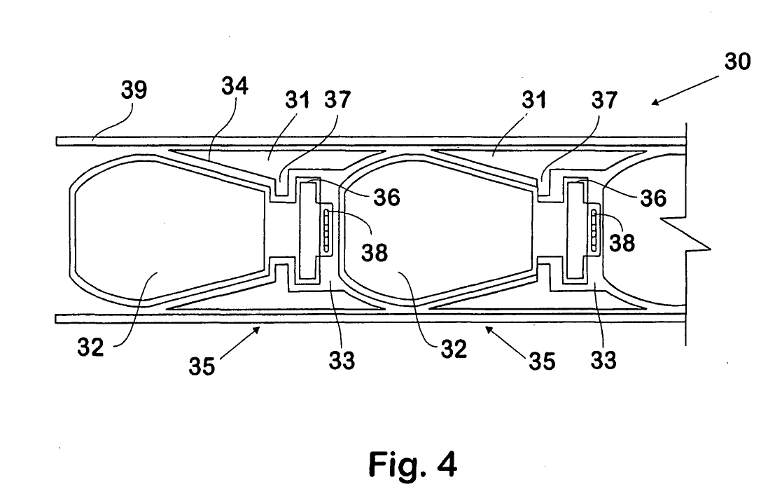

FIG. 3 shows a manually deployable pod 25 or mortar box containing a plurality of barrel assemblies 30 of different sizes having projectiles (see FIG. 4) that incorporate a fire retardant. The pod includes expandable walls 26 which are arranged to accommodate the mutual splaying of barrel assemblies 30, and a folding support structure 27 for orientating the barrels 30 in an inclined position. Such a pod 25 may be conveniently transported to a site near the fire and manually deployed in the field by a fire fighting team as required.

FIG. 4 shows a typical cross section of projectiles 35 loaded in a barrel 39, such as that comprised in the barrel assemblies 30 of the pod depicted in either FIG. 2 or 3. The projectiles 35 of the embodiment incorporate fire retardant powder in a containment 32 formed within a head portion of the projectile, and a propellant charge in a high pressure chamber 36 at the projectile tail. Upon ignition, combustion products of the propellant are exhausted through ports 38 into a low pressure chamber 33 to discharge the leading projectile 35 from the barrel 39.

The projectiles 35 sealably engage the bore of barrel 39 through a tapered sleeve 31 which is retained on the projectile by a shoulder portion 37 of the sleeve. The sleeve 31 extends rearwardly from the projectile head, constituting a spacer assembly for defining the low pressure chamber 33 and abutting an adjacent projectile therebehind. The sleeve 31 includes a wedging surface 34 which engages with a complementary surface on the projectile head, such that when compressive loads are applied to a column of projectiles loaded into the barrel 39, at least a portion of the sleeve 31 may be urged into operative sealing engagement with the bore of the barrel.

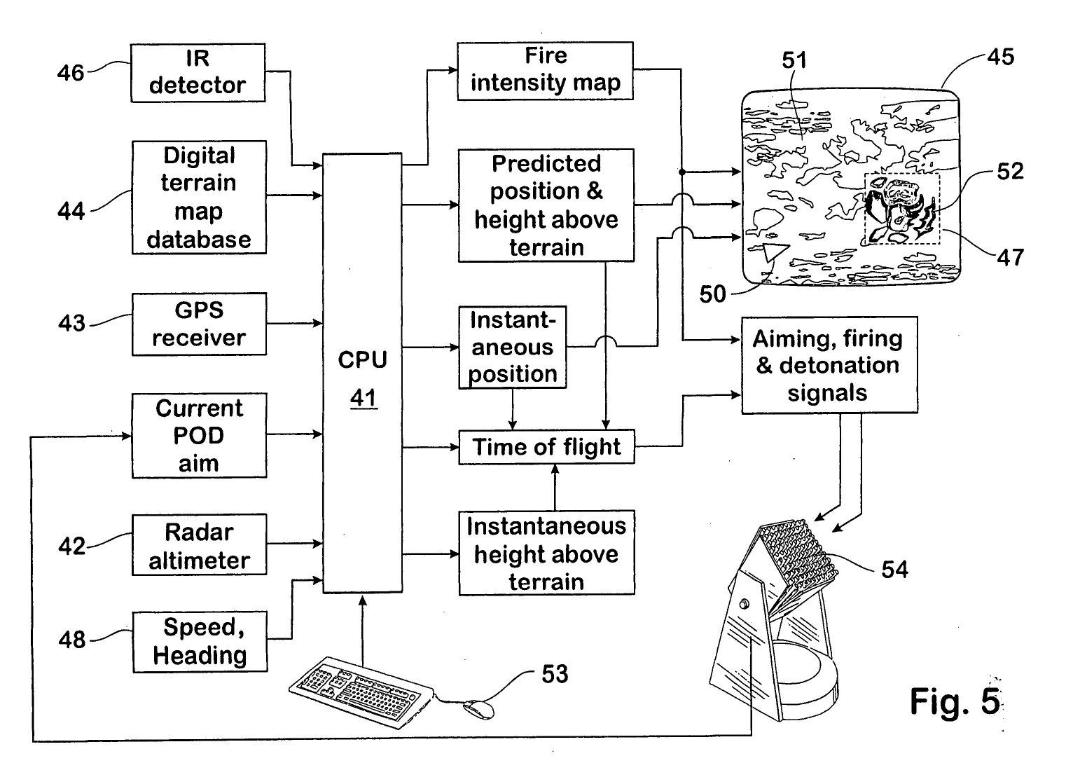

FIG. 5 illustrates a functional block diagram of a control system 40 for use with an airborne fire fighting unit of a further embodiment of the present invention. The control system includes a central processing unit (CPU) 41 which receives data from a variety of sensors, including those typically provided on a host aircraft carrying an array of projectile launching pods 54 similar to those described above. For example, a radar altimeter 42 provides instantaneous height of the aircraft above terrain and a global positioning system (GPS) receiver 43 can provide instantaneous position information. A digital terrain map database 44 can be used together with aircraft speed and heading information 48 in order to predict terrain to be traversed during flight, and to produce a representation of a terrain map 51 on a visual display unit 45 for use by an operator. The instantaneous position of the aircraft can be represented on the display by a suitable icon 50 generated from data provided by the GPS receiver 43.

The control system 40 also includes inputs for a targeting sub-system which comprises an infrared (IR) detection array 46 in the embodiment. The IR detector 46 suitably looks forward of the aircraft to produce a fire map 52, depicting the different intensity levels of the fire, for display as an overlay on the terrain map shown on the visual display unit 45. An operator can conveniently review the terrain and fire maps on the display 45 and designate an area of the fire to be targeted 47, such as using a pointing device 53 in conjunction with the display unit 45. The designated fire target area 47 can be utilised by the CPU, together with instantaneous and predicted height and position of the aircraft, to calculate the anticipated time of flight of projectiles and produce suitable aiming and projectile firing signals for the pod 54 and, if required, program detonation delays for selected projectiles. The density of projectiles can suitably be automatically determined on the basis of fire intensity revealed by the IR detector array 46, and the detonation delays in relation to a designated height for dispersal of the fire retardant from containments in the projectiles.

In an alternative arrangement, the aiming and firing of projectiles from the pod and programming of detonation delays can be conducted in relation to desired fire intensity. This arrangement can be used to target the hot spots in a much larger fire front.

The method and apparatus of the present invention allows precise targeting of hot spots in a fire, thereby preventing or at least containing the growth of a fire. Furthermore, where high value assets are threatened and/or lives are at stake, the fire front of concern may be more precisely targeted.

It will of course be realised that the above has been given by way of illustration only and that all such modifications as would be apparent to persons skilled in the art are deemed to fall within the broad scope and ambit of this invention as is herein set forth in the following claims

1. A fire fighting apparatus for fighting a fire having a relatively large area, said apparatus including:
(a) a targeting system for identifying a target area to be doused with fire retardant; and
(b) an ordnance for discharging a multiplicity of projectiles having the fire retardant contained therein, wherein said ordnance includes at least one barrel assembly, said at least one barrel assembly having a barrel, a plurality of projectiles axially disposed within the barrel for operative sealing engagement with the bore of the barrel, and discrete propellant charges for propelling respective projectiles sequentially through the muzzle of the barrel, whereby said fire retardant is dispersed over the target area.

2. The fire fighting apparatus of claim 1 wherein the ordnance includes a plurality of barrel assemblies, whereby said multiplicity of projectiles may be discharged simultaneously from respective barrels.

3. The fire fighting apparatus of either claim 1 or claim 2 wherein each projectile includes bursting means for opening a containment holding said fire retardant.

4. The fire fighting apparatus of claim 3 wherein said bursting means is activated upon impact, whereby the retardant may be dispersed from ground level.

5. The fire fighting apparatus of claim 3 wherein said bursting means is activated upon receipt of a signal broadcast to the projectiles, whereby the retardant may be dispersed at a designated height above ground level.

6. The fire fighting apparatus of any one of claims 3 to 5 wherein the bursting means comprises a mechanical assembly to disperse the fire retardant.

7. The fire fighting apparatus of any one of claims 3 to 5 wherein the bursting means comprises a small explosive charge.

8. The fire fighting apparatus of any one of claims 5 to 7 wherein the broadcast signal for activating the bursting means comprises a radio signal.

9. The fire fighting apparatus of any one of claims 5 to 7 wherein the broadcast signal for activating the bursting means comprises an optical signal.

10. The fire fighting apparatus of any one of claims 5 to 9 wherein said bursting means is at least partially heat activated.

11. The fire fighting apparatus of any one of claims 5 to 10 wherein said barrel assemblies are loaded with projectiles having bursting means that are activated at different predetermined delays after receipt of said broadcast signal.

12. The fire fighting apparatus of claim 3 wherein said barrel assemblies are loaded with projectiles having bursting means that are activated at different predetermined delays after discharge from respective barrels.

13. The fire fighting apparatus of either claim 1 or claim 2 wherein the ordnance comprises at least one pod containing a plurality of barrel assemblies.

14. The fire fighting apparatus of claim 13 wherein said at least one pod is responsive to the targeting system.

15. The fire fighting apparatus of either claim 13 or claim 14 wherein the plurality of barrel assemblies are able to be splayed relative to one another so that projectiles may be discharged in a concentrated or diffuse manner.

16. A method of fighting a fire having a relatively large area, said method including the steps of:
(a) providing an ordnance having at least one barrel assembly, said at least one barrel assembly having a barrel, a plurality of projectiles containing a fire retardant axially disposed within the barrel for operative sealing engagement with the bore of the barrel, and discrete propellant charges for propelling respective projectiles sequentially through the muzzle of the barrel;
(b) identifying a target area to be doused with fire retardant: and
(c) discharging a multiplicity of the projectiles having the fire retardant contained therein from the ordnance whereby said fire retardant is dispersed over the target area.

17. The fire fighting method of claim 16 wherein the ordnance includes a plurality of barrel assemblies and wherein the step of discharging said multiplicity of projectiles occurs simultaneously from respective barrels.

18. The fire fighting method of either claim 16 or claim 17 wherein the discharging step further includes the step of activating bursting means in each projectile for opening a containment therein holding said fire retardant.

19. The fire fighting method of claim 18 wherein said bursting means is activated upon impact, whereby the fire retardant may be dispersed from ground level.

20. The fire fighting method of claim 18 wherein said bursting means is activated upon receipt of a signal broadcast to the projectiles, whereby the fire retardant may be dispersed at a designated height above ground level.

21. The fire fighting method of any one of claims 18 to 20 wherein the step of discharging projectiles includes the further step of activating said bursting means at different predetermined delays, whereby the fire retardant may be dispersed at a plurality of heights above ground level.

22. A method of fighting a fire having a relatively large volume, said method including the steps of:
(a) providing an ordnance having a plurality of barrel assemblies, said barrel assemblies each having a barrel, a plurality of projectiles containing a fire retardant axially disposed within the barrel for operative sealing engagement with the bore of the barrel, and discrete propellant charges for propelling respective projectiles sequentially through the muzzle of the barrel;
(b) identifying a target volume to be doused with fire retardant: and
(c) discharging a multiplicity of the projectiles having the fire retardant contained therein from the ordnance whereby said fire retardant is dispersed through the target volume.

23. The fire fighting method of claim 22 wherein the discharging step further includes the step of activating bursting means in each projectile for opening a containment therein holding said fire retardant.

24. The fire fighting method of claim 23 wherein said bursting means is activated upon receipt of a signal broadcast to the projectiles, whereby the fire retardant may be dispersed at a designated height above ground level.

25. The fire fighting method of either claim 23 or claim 24 wherein the step of discharging projectiles includes the further step of activating said bursting means at different predetermined delays, whereby the fire retardant may be dispersed at a plurality of heights above ground level.
